(19) United States
(12) Patent Application Publication
(10) Pub. No.: US 2010/0297332 A1
(43) Pub. Date: Nov. 25, 2010

(54) Process For Preparation Of High-Fiber Product

(75) Inventors: Roger E. McPherson, Muscatine, IA (US); Jeff M. Underwood, Muscatine, IA (US); Frank W. Barresi, Muscatine, IA (US)

Correspondence Address: FITCH, EVEN, TABIN & FLANNERY, 120 SOUTH LASALLE STREET, SUITE 1600, CHICAGO, IL, 60603-3406, US

(73) Assignee: GRAIN PROCESSING CORPORATION, Muscatine, IA (US)

(21) Appl. No.: 12/777,919

(22) Filed: May 11, 2010

Related U.S. Application Data
(60) Provisional application No. 61/180,478, filed on May 22, 2009.

(51) Int. Cl. A23L 1/10

(52) U.S. Cl. 426/622; 426/436

(57) ABSTRACT

Disclosed is a process for treating a grain to form a product that is high in dietary fiber on the basis of dry solids content relative to the grain. Generally, the process includes subjecting the grain product to a destarching step, typically via aqueous treatment in warm water, followed by screening. The intermediate product thus formed is subjected to steam, typically in a jet cooking step, to yield a product that is higher in dietary fiber on a dry solids basis than the intermediate product previously formed. The grain is typically wheat bran, but may be other grains such as rice or oats.

### FIELD OF THE INVENTION

The invention is in the field of processing of grains. Some embodiments of the invention are directed towards the processing of wheat.

### BACKGROUND

Food products with a high fiber content are linked to a healthy diet. Improvements in health related to obesity, heart disease, diabetes and colon cancer have all been directly or indirectly linked to diets that are high in fiber.

Wet and dry milling techniques long have been used to isolate starch-rich fractions from grain such as corn, wheat, oats and rye. These techniques have evolved to maximize the levels of starch from these grains. As a result, a by-product of the milling processes is the outer coating of the grain, or bran. Bran typically has a low value and is primarily used as a feed ingredient.

Wheat bran fractions for the dry milling process are typically in the 20-40% fiber range. Attempts to further fractionate bran via modified rice polishing equipment to increase fiber content have been attempted (Trends in Food Science & Tech, February 1996, Vol. 7, pp 35-40). These processes include the Tkac system (US 5,387,430; 5,082,680), the PeriTec process (U.S. Pat. Nos. 5,390,589; 5,773,066; 5,846,591) the pearling Process (5,089,282; 5,194,287) and the peeling process (US application 2006/0147591; 5,650,018). These processes have been successful in producing fractions with fiber contents in excess of 70%. The focus of these processes is to provide wheat flour, with potential contaminants having been removed by de-branning the out layers of the wheat berry.

### SUMMARY

A grain product that is high in dietary fiber on a dry solids basis relative to a natural grain product can be prepared. Generally, the process for preparing the grain product includes subjecting a grain product to a destarching step, typically via aqueous treatment followed by screening. The intermediate product thus formed is subjected to steam, typically in a jet cooking step, to yield a product that is higher in dietary fiber on a dry solids basis than the intermediate product. It is believed that the jet cooking step offers a number of advantages. Jet cooking is believed to assist in removal of pesticides and other contaminants disposed on the grain. Additionally, the elevated temperatures are believed to assist in decontaminating the grain by sterilizing bacteria, fungi, and other microorganisms. Also, the elevated temperatures are believed to cause partial or complete denaturation of enzymes present in the grain. A grain product having in excess of 70% fiber on a dry solids basis may be produced in some embodiments.

### DETAILED DESCRIPTION OF THE PREFERRED EMBODIMENT

The invention is deemed applicable to any suitable grain, such as rice or oats, but most typically to a wheat product, and preferably wheat bran. The invention is deemed applicable to corn, such as a dry milled corn fraction. Oat bran or rice bran alternatively may be employed.

In wheat dry milling, the primary focus of the process is to separate the wheat endosperm from the bran and germ components to yield a high quality flour. The end result is a high quality wheat flour product that is high in starch content and low in fiber. The resulting tailing fractions which include components rich in bran and germ tend to have a fiber content of about 30-40%. Starch, protein, fat, ash and other residuals make up the balance of these fractions. This wheat bran is the preferred staring grain used in conjunction with the practice of the present invention.

Via practice of the embodiments described herein, a product having greater than 50% fiber on a dry solids basis may be provided. The product may have greater than 55%, greater than 60%, greater than 65%, greater than 70%, greater than 75%, greater than 80%, and possibly greater than 85% fiber on a dry solids basis.

The product may be prepared by first subjecting the grain to destarching treatment. The grain is destarched in some embodiments by aqueous treatment followed by screening. The aqueous treatment may include soaking in water at any suitable temperature, such as a temperature of 25°-65° C., and any suitable solids content, such as a solids content of from 5-20%, or, in some embodiments, 10-15%. A screen having a nominal mesh opening of 355 μm has been found useful in the screening step, but any suitable screen size may be used.

The liquid passing through the screen is high in starch content. This liquid may be dried, for instance via spray-drying, to yield dried starch. The heretofore described destarching step may cause removal of at least 40%, at least 45%, at least 50%, at least 55 at least 60%, at least 65%, at least 70%, or at least 75%, or possibly more, of the starch initially present in the grain.

The intermediate product thus formed will be higher in fiber on a dry solids basis than the starting material, vis-à-vis the removal of some of the starch initially present. This product is then subjected to steam at any suitable temperature and pressure to cause removal of additional soluble material. The steam temperature may be, for instance, 100°-250° C., and the pressure may be as supplied in a jet cooking apparatus. The high-fiber product then may be recovered and further processes, for instance, by drying and grinding.

The liquid recovered from the jet cooking apparatus may itself be dried, for instance via spray drying, or ay be concentrated. This liquid itself may contain denatured enzymes, other proteins, or other materials. The dried product or concentrate thus formed is deemed a commercially useful product for this reason.

The following non-limiting Examples are provided for illustration. These Examples should not be regarded as limiting the invention in scope.

### EXAMPLE 1

Commercial wheat bran derived from hard red winter wheat was assayed and found to have the following profile:

| | |
|---|---|
| % Solids | 87.22% |
| % Starch (dsb) | 17.16% dsb |
| % Protein (dsb) | 17.34% dsb |
| % Ash (dsb) | 5.92% dsb |
| % Fat (dsb) | 4.84% dsb |
| % Solubles | 22.36% dsb |

The commercial wheat bran, 400 lbs, was added to 500 gallons of water at 110° F. and stirred vigorously to form a slurry. The slurry was pumped and filtered across a DSM screen (screen opening=355 μm). The intermediate material retained on the DSM screen was assayed and found to have the following profile:

| | |
|---|---|
| % Solids | 18.35% dsb |
| % Starch | 3.97% dsb |
| % Protein | 13.06% dsb |

The material passing through the DSM screen was assayed and found to have the following profile:

| | |
|---|---|
| % Solids | 3.01% dsb |
| % Starch | 28.44% dsb |
| % Protein | 24.54% dsb |

The intermediate material was slurried in water at ca. 10 percent solids to form a slurry. This slurry was jet cooked at 305° F. for 5 minutes, and filtered across a MERCO centrifuge. The material passing through the MERCO centrifuge was assayed.

| | |
|---|---|
| % Solids | 2.20% dsb |
| % Starch | 21.37% dsb |
| % Protein | 21.22% dsb |

The material retained on the MERCO centrifuge was dried in a steam-jacketed ribbon blender. The dry product weighed 74.4 lbs and was assayed and found to have the following profile:

| | |
|---|---|
| % Solids | 97.82% |
| % Protein | 10.47% (dsb) |
| % Starch | 1.03% (dsb) |
| % Fat | 2.31% (dsb) |
| % Ash | 4.88% (dsb) |

This product was believed to have more fiber on a dry solids basis than the intermediate material and the beginning commercial wheat bran material.

### EXAMPLE 2

The commercial wheat bran from EXAMPLE 1, 200 g, was added to 2,000 mL of water at 110° F. and stirred vigorously to form a slurry. The slurry was filtered across a U.S.A. Standard Testing Sieve No. 45 screen (screen opening=355 μm). The intermediate material retained on the screen was assayed and found to have the following profile:

| | |
|---|---|
| % Solids | 23.48% dsb |
| % Starch | 6.09% dsb |
| % Protein | 17.00% dsb |

The material passing through the screen was assayed and found to have the following profile:

| | |
|---|---|
| % Solids | 4.17% dsb |
| % Starch | 35.60% dsb |
| % Protein | 33.57% dsb |

The material retained on the screen was slurried in water at ca. 10 percent solids. The slurry was boiled for 5 minutes and filtered across a filter cloth (filter cloth opening=200 μm). The material passing through the filter cloth was assayed and found to have the following profile:

| | |
|---|---|
| % Solids | 0.90% dsb |
| % Starch | 31.66% dsb |
| % Protein | 68.50% dsb |

The material retained on the filter cloth was dried in an oven at 70° C. The dry product weighed 66.5 g and was assayed and found to have the following profile:

| | |
|---|---|
| % Solids | 98.79% |
| % Protein | 13.56% (dsb) |
| % Starch | 1.28% (dsb) |
| % Fat | 3.58% (dsb) |
| % Ash | 4.43% (dsb) |

This product was believed to have more fiber on a dry solids basis than the intermediate material and the beginning commercial wheat bran material.

In many embodiments, the heretofore described process is scalable, economical and high yielding in comparison to other debranning technology. In addition, the aqueous process lends itself to producing a clean fiber fraction that is free from many of the contamination issues such as residues pesticides, heavy metals, microbes and fungi that are more common in dry processes. In addition, the wet process has an added advantage that the hot temperatures used effectively sterilize and stabilize the product.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. All references, including publications, patent applications, and patents, cited herein are hereby incorporated by reference. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. A process for preparing a fibrous grain product, comprising:
providing a grain product, said grain product containing starch and dietary fiber;
subjecting said grain product to a destarching treatment thereby providing an intermediate product, said intermediate product containing relatively less starch on a dry solids basis than said grain product; and
subjecting said intermediate product to steam to yield a fibrous grain product, said fibrous grain product having relatively more fiber on a dry solids basis than said intermediate product.

2. A process according to claim 1, said intermediate product being subjected to steam at a pressure greater than one atmosphere.

3. A process according to claim 2, said intermediate product being subjected to steam in a jet cooking device.

4. A process according to claim 1, said destarching step removing at least 30 percent of the starch initially present in said grain product.

5. A process according to claim 1, said destarching step removing at least 40 percent of the starch initially present in said grain product.

6. A process according to claim 1, said destarching step removing at least 50 percent of the starch initially present in said grain product.

7. A process according to claim 1, said fibrous product containing at least 50 percent dietary fiber on a dry solids basis.

8. A process according to claim 1, said fibrous product containing at least 60 percent dietary fiber on a dry solids basis.

9. A process according to claim 1, said fibrous product containing at least 70 percent dietary fiber on a dry solids basis.

10. A process according to claim 1, further comprising recovering at least some of the starch separated in the destarching step.

11. A process according to claim 1, said grain comprising wheat bran.

12. A process according to claim 1, said grain being selected from the group consisting of oat bran and rice bran.

13. A fibrous product prepared by a process comprising:
providing a grain product, said grain product containing starch and dietary fiber;
subjecting said grain product to a destarching treatment thereby providing an intermediate product, said intermediate product containing relatively less starch on a dry solids basis than said grain product; and
subjecting said intermediate product to steam to yield a fibrous grain product, said fibrous grain product having relatively more fiber on a dry solids basis than said intermediate product.

14. A process according to claim 13, said intermediate product being subjected to steam at a pressure greater than one atmosphere.

15. A process according to claim 14, said intermediate product being subjected to steam in a jet cooking device.

16. A process according to claim 13, said destarching step removing at least 30 percent of the starch initially present in said grain product.

17. A process according to claim 13, said destarching step removing at least 40 percent of the starch initially present in said grain product.

18. A process according to claim 13, said destarching step removing at least 50 percent of the starch initially present in said grain product.

19. A process according to claim 13, said fibrous product containing at least 50 percent dietary fiber on a dry solids basis.

20. A process according to claim 13, said fibrous product containing at least 60 percent dietary fiber on a dry solids basis.

21. A process according to claim 13, said fibrous product containing at least 70 percent dietary fiber on a dry solids basis.

22. A process according to claim 13, further comprising recovering at least some of the starch separated in the destarching step.

23. A process according to claim 13, said grain comprising wheat bran.

24. A process according to claim 13, said grain being selected from the group consisting of oat bran and rice bran.
